(19) United States
(12) Patent Application Publication
(10) Pub. No.: US 2008/0208581 A1
(43) Pub. Date: Aug. 28, 2008

(54) Model Adaptation System and Method for Speaker Recognition

(75) Inventors: Jason Pelecanos, Ossining, NY (US); Subramanian Sridharan, Queensland (AU); Robert Vogt, Queensland (AU)

Correspondence Address: FENWICK & WEST LLP, SILICON VALLEY CENTER, 801 CALIFORNIA STREET, MOUNTAIN VIEW, CA, 94041, US

(73) Assignee: Queensland University of Technology

(21) Appl. No.: 10/581,227

(22) PCT Filed: Dec. 3, 2004
(86) PCT No.: PCT/AU04/01718

§ 371 Date: Jun. 2, 2006

(30) Foreign Application Priority Data
Dec. 5, 2003 (AU) 2003906741

(51) Int. Cl. G10L 17/00

(52) U.S. Cl. 704/250; 704/E17.001

(57) ABSTRACT

A system and method for speaker recognition speaker modelling whereby prior speaker information is incorporated into the modelling process, utilising the maximum a posteriori (MAP) algorithm and extending it to contain prior Gaussian component correlation information. Firstly a background model (10) is estimated. Pooled acoustic reference data (11) relating to a specific demographic of speakers (population of interest) from a given total population is then trained via the Expectation Maximization (EM) algorithm (12) to produce a background model (13). The background model (13) is adapted utilising information from a plurality of reference speakers (21) in accordance with the Maximum A Posteriori (MAP) criterion (22). Utilizing MAP estimation technique, the reference speaker data and prior information obtained from the background model parameters are combined to produce a library of adapted speaker models, namely Gaussian Mixture Models (23).

### BACKGROUND OF THE INVENTION

1. Field of the Invention

The present invention generally relates to a system and method for speaker recognition. In particular, although not exclusively, the present invention relates to speaker recognition incorporating Gaussian Mixture Models to provide robust automatic speaker recognition in noisy communications environments, such as over telephony networks and for limited quantities of training data.

2. Discussion of the Background Art

In recent years, the interaction between computing systems and humans has been greatly enhanced by the use of speech recognition software. However, the introduction of speech based interfaces has presented the need for identifying and authenticating speakers to improve reliability and provide additional security for speech based and related applications.

Various forms of speaker recognition systems have been utilised in such areas as banking and finance, electronic signatures and forensic science. An example of one such system is that disclosed in International Patent Application WO 99/23643 by T-Netix, Inc entitled ‘Model adaptation system and method for speaker verification’. The T-Netix document describes a system and method for adapting speaker verification models to achieve enhanced performance during verification and particularly, to a sub-word based speaker verification system having the capability of adapting a neural tree network (NTN), Gaussian mixture model (GMM), dynamic time warping template (DTW), or combinations of the above, without requiring additional time consuming retraining of the models.

Another example of a speaker recognition system is disclosed in U.S. Pat. No. 6,088,699 by Maes (assigned to IBM) and is entitled ‘Speech recognition with attempted speaker recognition for speaker model pre-fetching or alternative speech modelling’. Maes describes a system of identifying a speaker by text-independent comparison of an input speech signal with a stored representation of speech signals corresponding to one of a plurality of speakers. The method of speaker recognition proposed by Maes utilises Vector Quantisation (VQ) scoring.

U.S. Pat. No. 6,411,930 by Burges (assigned to Lucent Technologies Inc.) entitled ‘Discriminative Gaussian mixture models for speaker verification’ discloses a method of speaker recognition that utilises a Discriminative Gaussian mixture model (DGMM). A likelihood sum of the single GMM is factored into two parts, one of which depends only on the Gaussian mixture model, and the other of which is a discriminative term. The discriminative term allows for the use of a binary classifier, such as a Support Vector Machine (SVM).

Another example of speaker recognition is discussed in U.S. Pat. No. 6,539,351 by Chen et al (assigned to IBM) and entitled ‘High dimensional acoustic modelling via mixtures of compound Gaussians with linear transforms’. Chen describes a method of modelling acoustic data with a combination of a mixture of compound Gaussian densities and a linear transform. All the methods disclosed for training the model combined with the linear transform utilise the Expectation Maximization (EM) method using an auxiliary function to maximise the likelihood.

The systems described above do not provide a speaker recognition algorithm which performs reliably under adverse communications conditions, such as limited enrolment speech, channel mismatch, speech degradation and additive noise, which typically occur over telephony networks.

It would be advantageous if a system and method of speaker recognition could be provided that is robust and would mitigate the effects of adverse communications conditions, such as channel mismatch, speech degradation and noise, while also enhancing speaker model estimation.

### SUMMARY OF THE INVENTION

### Disclosure of the Invention

In one aspect of the present invention there is provided a method of speaker modelling, said method including the steps of:

estimating a background model based on a library of acoustic data from a plurality of speakers representative of a population of interest;

training a set of Gaussian mixture models (GMMs) from constraints provided by a library of acoustic data from a plurality of speakers representative of a population of interest and the background model;

estimating a prior distribution of speaker model parameters using information from the trained set of GMMs and the background model, wherein correlation information is extracted from the trained set of GMMs;

obtaining a training sequence from at least one target speaker;

estimating a speaker model for each of the target speakers using a GMM structure based on the maximum a posteriori (MAP) criterion.

In another aspect of the present invention there is provided a system for speaker modelling, said system including:

a library of acoustic data relating to a plurality of background speakers;

a library of acoustic data relating to a plurality of reference speakers;

a database containing training sequence(s) said training sequence(s) relating to one or more target speaker(s);

a memory for storing a background model and a speaker model for said one or more target speakers; and

at least one processor coupled to said library, database and memory, wherein said at least one processor is configured to:
estimate a background model based on a library of acoustic data from a plurality of background speakers;
train a set of Gaussian mixture models (GMMs) from a library of acoustic data from a plurality of reference speakers and the background model;
estimate a prior distribution of speaker model parameters using information from the trained set of GMMs and the background model, wherein correlation information is extracted from the trained set of GMMs;
estimate a speaker model for said one or more target speaker(s), using a GMM structure based on the maximum a posteriori (MAP) criterion, wherein the MAP criterion is a function of the training sequence and the estimated prior distribution; and
store said background model and said speaker model in said memory.

In a further aspect of the present invention there is provided a method of speaker recognition, said method including the steps of:

estimating a background model based on a library of acoustic data from a plurality of background speakers;

training a set of Gaussian mixture models (GMMs) from a library of acoustic data from a plurality of reference speakers and the background model;

estimating a prior distribution of speaker model parameters using information from the trained set of GMMs and the background model, wherein correlation information is extracted from the trained set of GMMs;

obtaining a training sequence from at least one target speaker;

estimating a speaker model for each of the target speakers using a GMM structure based on the maximum a posteriori (MAP) criterion, wherein the MAP criterion is a function of the training sequence and the estimated prior distribution.

obtaining a speech sample from a speaker;

evaluating a similarity measure between the speech sample and the target speaker model and between the speech sample and the background model; and

identifying whether the speaker is one of said target speakers by comparing the similarity measures between the speech sample and said target speaker model and between the speech sample and the background model.

Other normalisations at the feature, model and score levels may also be applied to the said system.

In still yet another aspect of the present invention there is provided a system for speaker modelling and verification, said system including:

a library of acoustic data relating to a plurality of background speakers;

a library of acoustic data relating to a plurality of reference speakers;

a database containing training sequences said training sequences relating to one or more target speakers;

an input for obtaining a speech sample from a speaker;

a memory for storing a background model and a speaker model for said one or more target speakers; and

at least one processor wherein said at least one processor is configured to:
estimate a background model based on a library of acoustic data from a plurality of background speakers;
train a set of Gaussian mixture models (GMMs) from a library of acoustic data from a plurality of reference speakers and the background model;
estimate a prior distribution of speaker model parameters using information from the trained set of GMMs and the background model, wherein correlation information is extracted from the trained set of GMMs;
estimate a speaker model for said one or more target speaker(s), using a GMM structure based on the maximum a posteriori (MAP) criterion, wherein the MAP criterion is a function of the training sequence and the estimated prior distribution; and
store said background model and said speaker model in said memory.
obtain a speech sample from a speaker;
evaluate a similarity measure between the speech sample and the target speaker model and between the speech sample and the background model;
verify if the speaker is a target speaker by comparing the similarity measures between the speech sample and the target speaker model and between the speech sample and the background model; and
grant access to the speaker if the speaker is verified as a target speaker.

Preferably the MAP criterion is a function of the training sequence and the estimated prior distribution.

Suitably a library of correlation information is produced from the trained set of GMMs and the estimation of prior distribution of speaker model parameters is based on the library of correlation information and the background model. Most preferably, the library of correlation information includes the covariance of the mixture component means extracted from the trained set of GMM's. A prior covariance matrix of the component means may then be compiled based on this library of correlation information.

If required, an estimate of the prior covariance of the mixture component means may be determined by the use of various methods such as maximum likelihood, Bayesian inference of the correlation information using the background model covariance statistics as prior information or reducing the off-diagonal elements.

The library of acoustic data relating to a plurality of background speakers and the library of acoustic data relating to a plurality of reference speakers may be representative of a population of interest, including but not limited to, persons of selected ages, genders and/or cultural backgrounds.

The library of acoustic data relating to a plurality of reference speakers used to train the set of GMMs is preferably independent of the library of acoustic data used to estimate the background model, i.e. no speaker should appear in both the plurality of background speakers and the plurality of reference speakers. Most desirably, a target speaker must not be a background speaker or a reference speaker.

Preferably, the evaluation of the similarity measure involves the use of the expected frame-based log-likelihood ratio.

The background model may also directly describe elements of the prior distribution. Preferably, the present invention utilises full target and background model coupling.

The estimation of the prior distribution (in the form of the speaker model component mean prior distribution) may involve a single pass approach. Alternatively, the estimation of the prior distribution may involve an iterative approach whereby the library of reference speaker models are re-trained using an estimate of the prior distribution and the prior distribution is subsequently re-estimated. This process is then repeated until a convergence criterion is met.

The speech input for both training and testing may be directly recorded or may be obtained via a communication network such as the Internet, local or wide area networks (LAN's or WAN's), GSM or CDMA cellular networks, Plain Old Telephone System (POTS), Public Switched Telephone Network (PSTN), Integrated Services Digital Network (ISDN), various voice storage media, a combination thereof or other appropriate source.

The speaker verification and identification may further include post-processing techniques such as feature warping, feature mean and variance normalisation, relative spectral techniques (RASTA), modulation spectrum processing and Cepstral Mean Subtraction or a combination thereof to mitigate speech channel effects.

### BRIEF DETAILS OF THE DRAWINGS

In order that this invention may be more readily understood and put into practical effect, reference will now be made to the accompanying drawings, which illustrate preferred embodiments of the invention, and wherein:

FIG. 1 is a schematic block diagram illustrating the background model estimation process;

FIG. 2 is a schematic block diagram illustrating the process of obtaining a component mean covariance matrix in accordance with one embodiment of the invention;

FIG. 3 is a schematic block diagram illustrating speaker model estimation for a given target speaker in accordance with one embodiment of the invention;

FIG. 4 is a schematic block diagram illustrating speaker verification in accordance with one embodiment of the present invention;

FIG. 5 is a plot of Detection Error Trade off (DET) curves according to one embodiment of the present invention; and

FIG. 6 is a plot of the Equal Error Rates (EER) according to one embodiment of the present invention.

### DESCRIPTION OF EMBODIMENTS OF THE INVENTION

In one embodiment of the invention there is provided a method of speaker modelling whereby prior speaker information is incorporated into the modelling process. This is achieved through utilising the Maximum A Posteriori (MAP) algorithm and extending it to contain prior Gaussian component correlation information.

This type of modelling provides the ability to model mixture component correlations by observing the parameter variations between a selection of speaker models. In the prior art previous speaker recognition modelling work assumed that the adaptation of the mixture component means were independent of other mixture components.

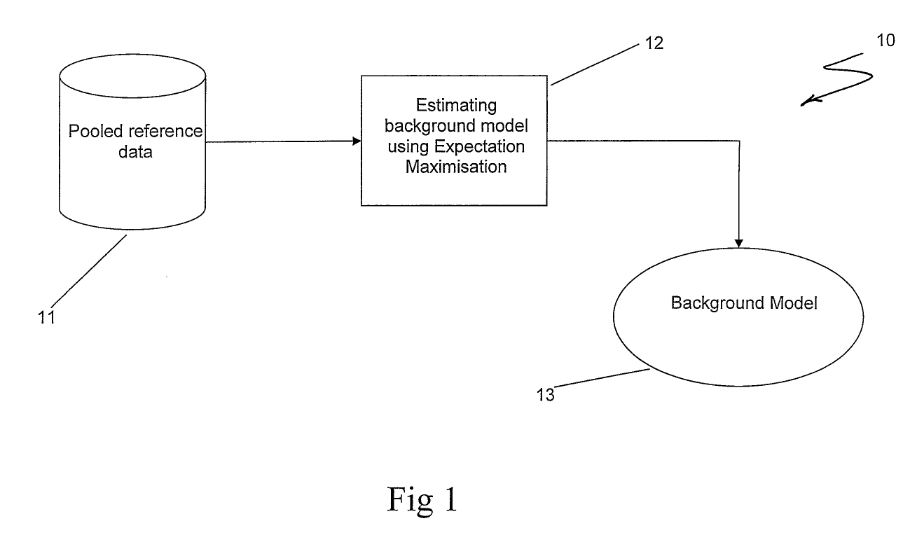

With reference to FIG. 1, there is illustrated the first stage in the modelling process of one embodiment of the present invention. Estimating a background model 10 for speaker recognition may be performed in accordance with various methods, which are well known in the art. In the present case, the Expectation Maximisation (EM) algorithm is used to produce the background model. Pooled acoustic reference data 11 relating to a specific demographic of speakers (population of interest) from a given total population is trained via the EM algorithm 12 to produce a background model 13 which is a general representation of the speech characteristics of the population of interest and is typically a large order Gaussian Mixture Model (GMM).

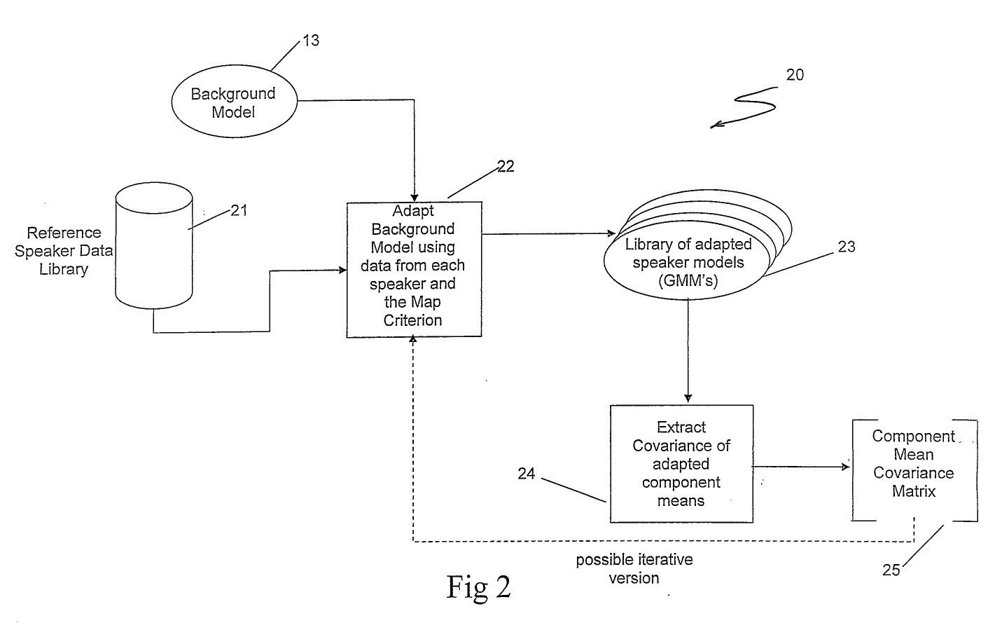

FIG. 2 depicts the second stage of the modelling process utilised by an embodiment of the present invention. The background model 13 is adapted utilising information from a plurality of reference speakers 21 in accordance with the Maximum A Posteriori (MAP) criterion 22. The reference speaker information within this stage of the process is composed of data samples, which represent the population of interest. However, the this reference speaker information differs from the pooled acoustic reference data 11 used to obtain the background model in that it relates to a second group of speakers from the same demographic (i.e. no sample overlap). This preserves the statistical independency of the modelling process.

Utilizing MAP estimation the reference speaker data and prior information obtainable from the background model parameters are combined to produce a library of adapted speaker models, namely Gaussian Mixture Models 23.

Using the Bayesian Inference approach, the model parameter set λ for a single model is optimized according to MAP estimation criterion given a speech utterance X. The MAP optimization problem may be represented as follows.

$${λ}_{MAP} = \text{arg} {max}_{λ} p ( X \vert λ ) p ( λ ) \qquad ( Eq . 1 )$$

One approach is to have p(X|λ) described by a mixture of Gaussian component densities, while p(λ) is established as the joint likelihood of ωᵢ, μᵢ and Σᵢ being the weights, means and diagonal covariances of the Gaussian components respectively. The fundamental assumption specified by the prior information, without consideration of the mixture component weight effects, is that all mixture components are independent. Thus p(λ) could be represented as the product of the joint GMM weight likelihood with the product of the individual component mean and covariance pair likelihoods as given by equation (2).

$$p ( λ ) = g ( {w}_{1} , {w}_{2} , … , {w}_{N} ) {\prod }_{i = 1}^{N} g ( {μ}_{i} , {Σ}_{i} \vert {Θ}_{i} ) \qquad ( Eq . 2 )$$

Here, let g(ω₁, ω₂, . . . , ω_{N}) be represented as a Dirichlet distribution and g(μᵢ,Σᵢ|Θᵢ) be a Normal-Wishart density. The Dirichlet density is the conjugate prior density for the parameters of a multinomial density and the Normal-Wishart density is the prior for the parameters of the normal density.

This form of joint likelihood calculation assumes that the probability density function of the component weights is independent of the mixture component means and covariances. In addition, the joint distribution of the mean and covariance elements is independent of all other mean and covariance parameters from other Gaussians in the mixture.

Thus, the MAP solution is solved by maximizing the following auxiliary function defined by equation (3).

$$ψ ( λ , \hat{λ} ) ∝ p ( λ ) {\prod }_{i = 1}^{N} {w}_{i}^{{c}_{i}} {\vert {Σ}_{i}^{- 1} \vert}^{\frac{{c}_{i}}{2}} exp \{ - \frac{{c}_{i}}{2} {( {μ}_{i} - {\overline{x}}_{i} )}^{′} {Σ}_{i}^{- 1} ( {μ}_{i} - {\overline{x}}_{i} ) - \frac{1}{2} tr ( {S}_{i} {Σ}_{i}^{- 1} ) \} \\ where \begin{matrix}{c}_{it} = Pr ( i \vert {x}_{t} , \hat{λ} ) \\ = \frac{{\hat{w}}_{i} g ( {x}_{t} \vert {\hat{μ}}_{i} , {\hat{Σ}}_{i} )}{{\sum }_{j = 1}^{N} {\hat{w}}_{j} g ( {x}_{t} \vert {\hat{μ}}_{j} , {\hat{Σ}}_{j} )}\end{matrix} \\ {c}_{i} = {\sum }_{i = 1}^{T} {c}_{it} \\ {\overline{x}}_{i} = {\sum }_{t = 1}^{T} \frac{{c}_{it} {x}_{t}}{{c}_{i}} \\ {S}_{i} = {\sum }_{t = 1}^{T} {c}_{it} ( {x}_{t} - {\overline{x}}_{i} ) {( {x}_{t} - {\overline{x}}_{i} )}^{′} \qquad ( Eq . 3 )$$

This is achieved by using the Expectation-Maximization procedure to maximize this function. Under the assumption that only the mixture component means will be adapted, the resulting EM algorithm auxiliary function is presented in equation (4)

$$ψ ( λ , \hat{λ} ) ∝ g ( λ ) {\prod }_{i = 1}^{N} exp \{ - \frac{{c}_{i}}{2} {( {μ}_{i} - {\overline{x}}_{i} )}^{′} {r}_{i} ( {μ}_{i} - {\overline{x}}_{i} ) \} \qquad ( Eq . 4 )$$

Here λ and \hat{λ} are the new and old model estimates as a function of the mixture component means. The variable cᵢ is the accumulated probability count

$$( {c}_{i} = {\sum }_{t = 1}^{T} {c}_{it} ) with {c}_{it} = \frac{{w}_{i} g ( {x}_{t} \vert {\hat{μ}}_{i} , {Σ}_{i} )}{{\sum }_{j = 1}^{N} {w}_{j} g ( {x}_{i} \vert {\hat{μ}}_{j} , {Σ}_{j} )} )$$

for mixture component i and rᵢ is the diagonal precision matrix for each Gaussian component i (rᵢ=Σᵢ⁻¹). The vectors μᵢ and \hat{μ}ᵢ are the ith new and old adapted Gaussian means respectively, and x̅ᵢ=Σₜ₌₁^{T}=cᵢₜxₜ/cᵢ.

For the purposes of the present invention it is assumed that the distribution of the joint mixture component means is governed by a high dimensionality Gaussian density function. In order to represent this density, let the joint vector of the concatenated Gaussian means be represented as follows. In some works, this is described using the vec{•} operator.

$$M = [ \begin{matrix}{μ}_{1} \\ {μ}_{2} \\ ⋮ \\ {μ}_{N}\end{matrix} ] \qquad ( Eq . 5 )$$

Let the concatenated vector means have a global mean given by μ_{G} and a precision matrix given by r_{G}. Thus, for N mixture component means, with feature dimensionality D, M is a vector of length ND, while r_{G} is an ND by ND square matrix. Thus the matrix r_{G}⁻¹ is comprised of N by N sets of D by D covariance blocks (with each block identified as Σᵢⱼ) between the corresponding D parameters of the ith and jth mixture component mean vectors. Given these conditions, the distribution of the concatenated means may be given in full composite form such that g(λ) is proportional to the following.

$$g ( λ ) ∝ exp \{ - \frac{1}{2} {{( [ \begin{matrix}{μ}_{1} \\ {μ}_{2} \\ ⋮ \\ {μ}_{N}\end{matrix} ] - [ \begin{matrix}{μ}_{G 1} \\ {μ}_{G 2} \\ ⋮ \\ {μ}_{GN}\end{matrix} ] )}^{′} [ \begin{matrix}{Σ}_{11} & {Σ}_{12} & ⋯ & {Σ}_{1 N} \\ {Σ}_{21} & {Σ}_{22} & & {Σ}_{2 N} \\ ⋮ & & ⋰ & ⋮ \\ {Σ}_{N 1} & {Σ}_{N 2} & ⋯ & {Σ}_{NN}\end{matrix} ]}^{- 1} ( [ \begin{matrix}{μ}_{1} \\ {μ}_{2} \\ ⋮ \\ {μ}_{N}\end{matrix} ] - [ \begin{matrix}{μ}_{G 1} \\ {μ}_{G 2} \\ ⋮ \\ {μ}_{GN}\end{matrix} ] ) \} \qquad ( Eq . 6 )$$

Equation (6) may be given in the following symbolic compressed form

$$g ( λ ) ∝ exp \{ - \frac{1}{2} {( M - {μ}_{G} )}^{′} {r}_{G} ( M - {μ}_{G} ) \} \qquad ( Eq . 7 )$$

In addition, the remainder of auxiliary equation (4) must be represented in a similar matrix and vector form. The result is present in equation (8).

$${\prod }_{k = 1}^{N} exp \{ - \frac{{c}_{i}}{2} {( {μ}_{i} - {\overline{x}}_{i} )}^{′} {r}_{i} ( {μ}_{i} - {\overline{x}}_{i} ) \} = exp \{ - \frac{1}{2} {( M - \overline{x} )}^{′} Cr ( M - \overline{x} ) \} \\ Where r = {( \begin{matrix}{Σ}_{1} & 0 & ⋯ & 0 \\ 0 & {Σ}_{2} & 0 & ⋮ \\ ⋮ & 0 & ⋰ & 0 \\ 0 & ⋯ & 0 & {Σ}_{N}\end{matrix} )}^{- 1} \\ and C = ( \begin{matrix}{C}_{1} & 0 & ⋯ & 0 \\ 0 & {C}_{2} & 0 & ⋮ \\ ⋮ & 0 & ⋰ & 0 \\ 0 & ⋯ & 0 & {C}_{N}\end{matrix} ) with {C}_{i} = ( \begin{matrix}{c}_{i} & 0 & ⋯ & 0 \\ 0 & {c}_{i} & 0 & ⋮ \\ ⋮ & 0 & ⋰ & 0 \\ 0 & ⋯ & 0 & {c}_{i}\end{matrix} ) = {c}_{i} I \qquad ( Eq . 8 )$$

The matrix C is a strictly diagonal matrix of dimension ND by ND. This matrix is comprised of diagonal block matrices C₁, C₂, . . . , C_{N}. Each matrix Cᵢ is a D dimensional identity matrix scaled by the mixture component accumulated probability count cᵢ that was defined earlier.

Given this information, the equation for maximizing the likelihood can be determined. The equation in this form can be optimized (to the degree of finding a local maxima) by use of the Expectation-Maximization algorithm. This gives the following auxiliary function representation shown in equation (9).

$$ψ ( λ , \hat{λ} ) ∝ exp \{ - \frac{1}{2} {( M - {μ}_{G} )}^{′} {r}_{G} ( M - {μ}_{G} ) \} \times exp \{ - \frac{1}{2} {( M - \overline{x} )}^{′} Cr ( M - \overline{x} ) \} \qquad ( Eq . 9 )$$

Expressing this in natural logarithmic from results in equation (10).

$$ln ψ ( λ , \hat{λ} ) = - \frac{1}{2} {( M - {μ}_{G} )}^{′} {r}_{G} ( M - {μ}_{G} ) - \frac{1}{2} {( M - \overline{x} )}^{′} Cr ( M - \overline{x} ) + constant \qquad ( Eq . 10 )$$

Taking the partial derivates with respect to each element of M gives

$$\frac{\partial ln ψ ( λ , \hat{λ} )}{\partial M} = - 2 ( Cr + {r}_{G} ) M + 2 ( Cr \overline{x} + {r}_{G} {μ}_{G} ) \qquad ( Eq . 11 )$$

In determining the partial derivatives, the following equalities prove useful. Here m is an arbitrary variable vector and T is a symmetric matrix (i.e. T=T′).

$$\frac{\partial {m}^{′} T}{\partial m} = T$$

$$\frac{\partial Tm}{\partial m} = {T}^{′}$$

$$\frac{\partial {m}^{′} Tm}{\partial m} = 2 Tm$$

In order to locate the stationary points of the auxiliary function as expressed in equation (11), the derivative is set to zero, i.e.

$$\frac{\partial ln ψ ( λ , \hat{λ} )}{\partial M} = 0.$$

This reduces the equation to the form represented in equation (12).

(Cr+r_{G})M=Cr x̅+r_{G}μ_{G} (Eq. 12)

Solving for M yields the MAP solution

M=(Cr+r_{G})⁻¹(Cr x̅+r_{G}μ^{G}) (Eq. 13)

This is reducible into the form of a weighted contribution of prior and new information.

M=a_{M} x̅+(I−a_{M})μ_{G} (Eq. 14)
where a_{M}=(Cr+r_{G})⁻¹Cr
(I−a_{M})=(Cr+r_{G})⁻¹r_{G}
   Now given that the global mean μ_{G} is set to the concatenated background model means, the factor a_{M} contains information relating to the proportion of new to old information contained in the background model that is to be included in the adaptation process.

Now that the adaptation equation is capable of handling the prior correlation information within the MAP adaptation framework one method for determining the global correlation components is the Maximum Likelihood criterion. The Maximum Likelihood criterion estimates the covariance matrix through the parameter analysis of a library of Out-Of-Set (OOS) speaker models. If the correlation components describe the interaction between the mixture mean components appropriately, the adaptation process can be controlled to produce an optimal result. The difficulty with the data based approach is the accurate estimation of the unique parameters in the ND by ND covariance matrix. For a complete description of the matrix, at least ND+1 unique samples are required to avoid a rank deficient matrix or density function singularity. This implies that at least ND+1 speaker models are required to satisfy this constraint. This requirement alone can be prohibitive in terms of computation and speech resources. For example, a 128 mode GMM with 24 dimensional features requires at least 3073 well-trained speaker models to calculate the prior information.

The Maximum Likelihood solution involves finding the covariance statistics using only then out-of-set speaker models. So, if there are s^{OOS} out-of-set models trained from a single background model with the concatenated mean vector extracted from the jth model given by, μⱼ^{OOS} the covariance matrix estimate, Σ_{G}^{ML}, is simply calculated with equation (15). If the estimate for the mean μ_{G}^{ML} is known, then equation (16) need not be used. Such an example is where the background component means are substituted for μ_{G}^{ML}.

$$\begin{matrix}{Σ}_{G}^{ML} = \frac{1}{{s}^{ass} - 1} {\sum }_{j = 1}^{{s}^{OOS}} ( {μ}_{j}^{OOS} - {μ}_{G}^{ML} ) {( {μ}_{j}^{OOS} - {μ}_{G}^{ML} )}^{′} \\ with & ( Eq . 15 ) \\ {μ}_{G}^{ML} = \frac{1}{{s}^{OOS}} {\sum }_{j = 1}^{{s}^{OOS}} {μ}_{j}^{OOS} & ( Eq . 16 )\end{matrix}$$

Unfortunately, if there are insufficient models to represent the covariance matrix, the matrix becomes rank deficient and no inverse can be determined. This difficulty of a rank-deficient covariance matrix is shared with subspace adaptation approaches such as “eigenvoice” analysis that are applied in both speech and speaker recognition. This difficulty may be resolved through a number of methods described below, that are also applicable to eigenvoice analysis.

One method involves Principal Component Analysis (PCA). This approach involves decomposing the matrix representation into its principal components. Once the principal components have been extracted, they may be used in conjunction with (empirical, data-derived or other) diagonal covariance information for adaptation. Restricting adaptation solely to this lower dimensional principal component subspace likewise restricts the capability for adapting model parameters outside the subspace. This causes performance degradation for larger quantities of adaptation data, which may be alleviated by using a combined approach. Ideally, a technique that can exploit some of the significant principal components of variation information with other adaptation statistics may operate robustly for both short and lengthy training utterances. In this manner, the principal components may restrict the adaptation to a subspace for small quantities of speech and will converge to the maximum likelihood solution for larger recordings.

Another solution for avoiding the generation of a singular covariance matrix, but not necessarily limited to this, is to reduce the magnitude of the non-diagonal covariance components. This approach allows the inverse of the matrix to be determined. It also permits the covariance matrix to allow adaptation of the target model parameters outside the adaptation subspace defined by the OOS speaker variations. The covariance estimation, given that the global mean is known, is performed using equation (17). Here diag{•} represents the diagonal covariance matrix and ξ_{d} is generally a small number near zero but between zero and one.

Σ_{G}=ξ_{d}diag{Σ_{G}^{ML}}+(1−ξ_{d})Σ_{G}^{ML} (Eq. 17)

Another possible method for determining the global correlation components is Bayesian adaptation of the covariance and (if required) the mean estimates by combining the old estimates from the background model with new information from a library of reference speaker models. The reference speaker data library is comprised of s^{OOS} out-of-set speaker models represented by the set of concatenated mean vectors, {μⱼ^{OOS}}. In addition, the old mean and covariance statistics are given by μ_{G}^{old} and Σ_{G}^{old} respectively.

$$\begin{matrix}{Σ}_{G}^{adapt} = ξ E \{ {μ}_{j}^{OOS} {μ}_{j}^{{OOS}^{′}} \} + ( 1 - ξ ) ( {Σ}_{G}^{old} + {μ}_{G}^{old} {μ}_{G}^{{old}^{′}} ) - {μ}_{G}^{adapt} {μ}_{G}^{{adapt}^{′}} & ( Eq . 18 ) \\ {μ}_{G}^{adapt} = {ξμ}_{G}^{ML} + ( 1 - ξ ) {μ}_{G}^{old} \\ with & ( Eq . 19 ) \\ E \{ {μ}_{j}^{OOS} {μ}_{j}^{{OOS}^{′}} \} = \frac{1}{{s}^{OOS}} {\sum }_{j = 1}^{{s}^{OOS}} {μ}_{j}^{OOS} {μ}_{j}^{{OOS}^{′}} & ( Eq . 20 ) \\ ξ = \frac{{s}^{OOS}}{{s}^{OOS} + {s}^{old}} & ( Eq . 21 )\end{matrix}$$

If the global mean vector estimate is known then μ_{G}^{adpt}=μ_{G}^{old}=μ_{G}^{ML}. One estimate may be to set these parameters to the background model mean vector μ_{G}^{BM}. In the instance that the mean of the Gaussian distribution is known, and only the covariance information is adapted, the adapted covariance becomes equation (22).

Σ_{G}^{adapt}=ξΣ_{G}^{ML}+(1−ξ)(τr)⁻¹ (Eq. 22)

The prior estimate of the global covariance, according to standard adaptation techniques, is given by (τr)⁻¹ while the new information is supplied by the covariance statistics determined from the collection of OOS speaker models. The hyperparameter τ is the relevance factor for the standard adaptation technique and the matrix r is the diagonal concatenation of the Gaussian mixture component precision matrices. The variable ξ is a tuning factor that represents how important the sufficient statistics, which are derived from the ML trained OOS models, are relative to the UBM based diagonal covariance information. Now, if the OOS model derived covariance information is unreliable, ξ should reduce to 0. In this case, the adaptation equation then resolves into the basic coupled mixture component mean adaptation system i.e. M=(Cr+r_{G})⁻¹(Cr x̅+r_{G}μ_{G}) becomes M=(Cr+τI)⁻¹(C x̅+τμ_{G}). However, as the value of ξ increases, the emphasis on using covariance information derived from the multiple OOS speaker models is increased. The strength of MAP estimation of the covariance statistic is that the adapted covariance matrix will not be rank deficient provided the old covariance information is of full rank and ξ is less than 1.

Thus in accordance with the EM algorithm with the MAP criterion the reference speaker data X^{OOS} 21 is utilised to adapt the background model for each speaker contained in the reference speaker data library to form a set of adapted speaker models in the form of GMM's 23.

The covariance statistics of the component means are then extracted from this adapted library of models 24 using standard techniques, see equation 15. The resultant of this extraction is the formation of a component mean covariance (CMC) matrix 25. The CMC matrix may then be used in conjunction with the background model 13 to estimate the prior distribution for controlling the target speaker adaptation process.

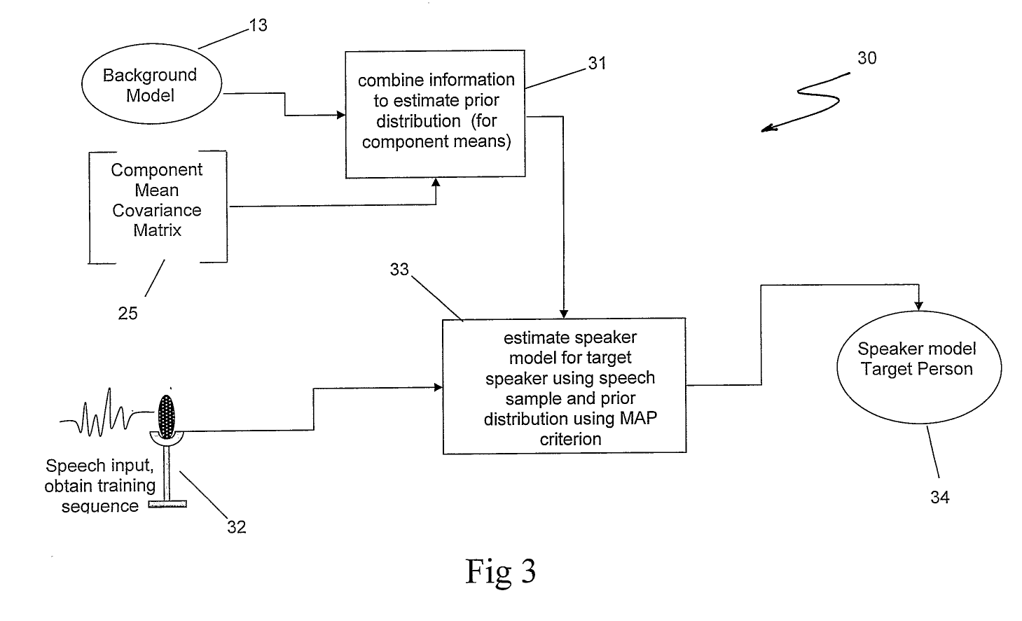

With reference to FIG. 3, there is illustrated the third stage of the modelling process utilised by the present invention. The background model 13 and the CMC matrix 25 are combined to estimate the prior distribution 31 for the set of component means.

Alternatively, the CMC matrix may be used in further iterations of reference speaker model training, in this instance the CMC data is fed back to re-train the reference speaker data with the background model, and then re-estimating the CMC matrix. This joint optimization process allows for variations of the mixture components to not only become dependent on previous iterations but also on other components further refining the MAP estimates. Several criteria may be used for this joint optimization of the reference models with the prior statistics, such as the maximum joint a posteriori probability over all reference speaker training data, eg.

$${Σ}_{G}^{MAP} = \text{arg} {max}_{{Σ}_{G}} {\sum }_{i} log {max}_{{λ}_{i}} p ( {X}_{i} \vert {λ}_{i} ) p ( {λ}_{i} \vert {Σ}_{G} ) \qquad ( Eq . 23 )$$

A training sequence is acquired for a given target speaker either directly or from a network 32. For normal training of speaker recognition models at least 1 to 2 minutes of training speech is required. This training sequence and the prior distribution estimate 31 are then utilised in conjunction with the MAP criterion as derived in the above discussion to estimate a speaker model for a given target speaker 34.

The target speaker model produced in this instance incorporates model correlations into the prior speaker information. This enables the present invention to handle applications where the length of the training speech is limited.

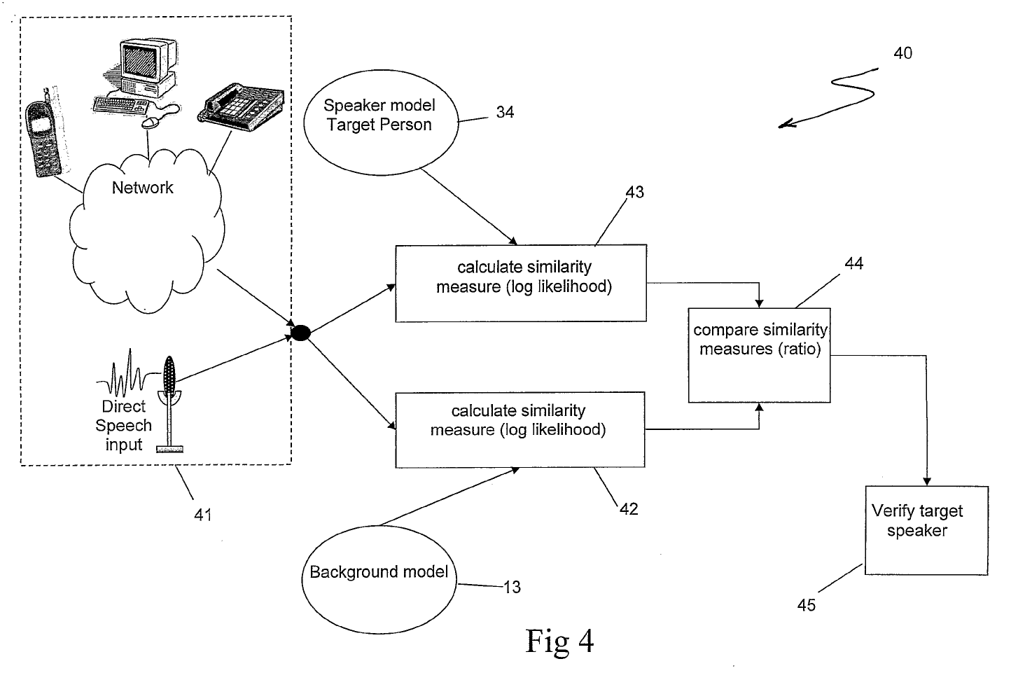

FIG. 4 illustrates one possible application of the present invention namely that of speaker verification 40. A speech sample 41 is obtained either directly or from a network. The sample is compared against the target model 43 and the background model 42 to produce similarity measures for the sample against the target and background models. The similarity measure is preferably calculated using the expected log likelihood. When comparing the likelihood between classes the likelihood ratio may be treated as independent of the prior target and impostor class probabilities P(λₜₐᵣ) and P(λₙₒₙ). The LR statistic is expressed as:

$$LR ( {x}_{t} ) = \frac{p ( {x}_{t} \vert {λ}_{tar} )}{p ( {x}_{t} \vert {λ}_{non} )} \qquad ( Eq . 24 )$$

For ease of mathematically manipulating the solution the logarithm is taken, resulting in the Log Likelihood Ratio (LLR) which is given as:

LLR(xₜ)=log p(xₜ|λₜₐᵣ)−log p(xₜ|λₙₒₙ) (Eq. 25)

If the likelihoods are in fact probability densities, the likelihood ratio of a single observation, may be used to determine the target speaker probability given that the sample was taken from either the target or non-target speaker distributions.

$$P ( {λ}_{tar} \vert {x}_{t} ) = \frac{LR ( {x}_{t} ) P ( {λ}_{tar} )}{LR ( {x}_{t} ) P ( {λ}_{tar} ) + P ( {λ}_{non} )} \qquad ( Eq . 26 )$$

Given T observations, assumed independent and identically distributed, X=(x₁, x₂, . . . , x_{T}), the ratio of the joint likelihoods in log form is given.

$$LLR ( X ) = {\sum }_{t = 1}^{T} log p ( {x}_{t} \vert {λ}_{tar} ) - log p ( {x}_{t} \vert {λ}_{non} ) \qquad ( Eq . 27 )$$

In practical applications, this estimate for a target speaker model figure of merit is not a robust measure, since the observations are not independent or identically distributed and also that there is a dependence between the background model and the coupled target models. A more robust measure for speaker verification is the expected log-likelihood ratio measure given by equation 28. This measure is typically used in forensic casework applications and is typically compensated for environmental effects through score normalisation.

$$\begin{matrix}E [ LLR ( {x}_{t} ) ] = E [ log p ( {x}_{t} \vert {λ}_{tar} ) - log p ( {x}_{i} \vert {λ}_{non} ) ] \\ = \frac{1}{T} {\sum }_{t = 1}^{T} ( log p ( {x}_{t} \vert {λ}_{tar} ) - log p ( {x}_{t} \vert {λ}_{non} ) )\end{matrix} \qquad \begin{matrix}\begin{matrix}( Eq . 28 ) \\ \end{matrix} \\ ( Eq . 29 )\end{matrix}$$

A similarity measure is then calculated in the above manner for the acquired speech sample 41 compared with the background model 42 and for the acquired speech sample compared with the speaker model of the target person 43. These measures are then compared 44 in order to determine if the speech sample is from the target person 45.

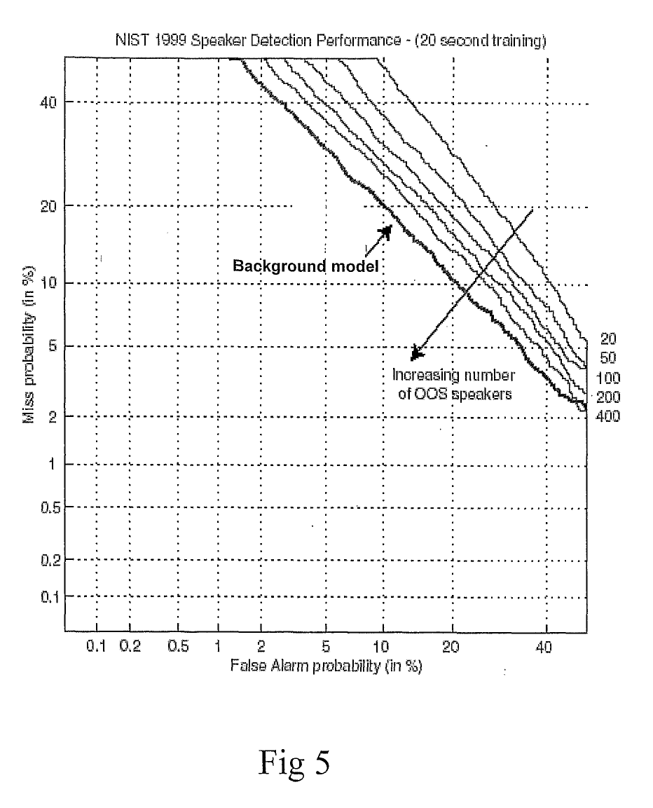

To demonstrate the effect of including correlation information, the present invention will be discussed with reference to FIG. 5 which represents the speaker detection performance of one embodiment of the present invention.

In this instance, a fully coupled target and background model structure was adapted using the above-described approach. Here, model coupling refers to the target model parameters being derived from a function of the training speech and the background model parameters. In the limit sense when there is no training speech the target speaker model is represented as the background model. The embodied system also utilised a feature warping parameterization algorithm and performed scoring of a test segment via the expected log-likelihood ratio test of the adapted target model versus the background model.

The system evaluation was based on the NIST 2000 and 1999 Speaker Recognition Databases. Both databases provide approximately 2 minutes of speech for the modelling of each speaker. The NIST 2000 database represented a demographic of 416 male speakers recorded using electret handsets. The information of the 2000 database was used to determine the correlation statistics. While the first 5 and 20 seconds of speech per speaker in the 1999 database was used as the training samples.

Detection Error Trade-off (DET) curves for the system are shown in FIG. 5, the system curves are based on 20 second lengths of speech for a set of male speakers processed according to the extended MAP estimation condition, and whereby the number of out-of-set (OOS) speakers was increased for each estimation of the covariance matrix statistics. The selection of OOS speakers involved using 20, 50, 100, 200 and 400 speakers. The result for the baseline background model is also identified in the plot. Because the number of OOS speakers is less than the number of rows or columns in the matrix, the matrix is singular. To avoid this problem, the non-diagonal components of the covariance matrix are deemphasized by 0.1%. It is clear from FIG. 5 that utilising the correlation information in the modelling process yields a continued increase in performance for an increasing number of OOS speakers used in estimation of the covariance matrix. It is important to note that the number of speakers is significantly below the minimum of 3073 speakers required for a non-singular matrix estimate without the need of deemphasizing the non-diagonal covariance components. Ideally, the evaluation requires the number of OOS speakers to be an order of magnitude more. However, the improvement in performance by using the correlation information in the modelling process is apparent from FIG. 5.

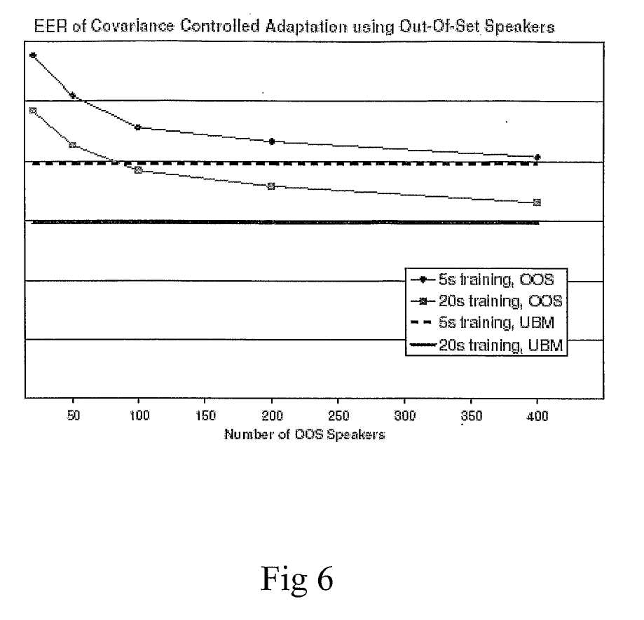

FIG. 6 illustrates a plot of equal error rate performances for the 20-second training utterances and for 5-second utterances for the system of FIG. 5. For 5 seconds of training speech, using the correlation information, the EER is reduced from 28.8% for 20 speakers to 20.4% for 400 speakers. Correspondingly, the 20 second results indicated an improving performance trend of 24.3% EER for 20 speakers down to 16.6% EER for 400 speakers. In both instances the background model based system performance exceeded that of the best covariance approximation system giving a 14.8% EER. However it is to be noted that background model based system error rates would be outperformed by the covariance prior estimate system if more OOS speakers were available as the background model baseline covariance matrix is far from becoming an accurate estimate of the true covariances.

It is to be understood that the above embodiments have been provided only by way of exemplification of this invention, and that further modifications and improvements thereto, as would be apparent to persons skilled in the relevant art, are deemed to fall within the broad scope and ambit of the present invention defined in the following claims.

What is claimed is:

1. A system for speaker modelling, said system comprising:
a library of acoustic data relating to a plurality of background speakers, representative of a population of interest;
a library of acoustic data relating to a plurality of reference speakers, representative of a population of interest;
a database containing at least one training sequenced, said training sequence relating to one or more target speakers;
a memory for storing a background model and a speaker model for said one or more target speakers; and
at least one processor coupled to said library, database and memory, wherein said at least one processor is configured to:
estimate a background model based on a library of acoustic data from a plurality of background speakers;
train a set of Gaussian mixture models (GMMs) from a library of acoustic data from a plurality of reference speakers and the background model;
estimate a prior distribution of speaker model parameters using information from the trained set of GMMs and the background model, wherein correlation information is extracted from the trained set of GMMs;
estimate a speaker model for said one or more target speaker(s), using a GMM structure based on the maximum a posteriori (MAP) criterion; and
store said background model and said speaker model in said memory.

2. The system of claim 1 wherein the MAP criterion for the speaker model is a function of the training sequence and the estimated prior distribution.

3. A system for speaker modelling and verification, said system including:
a library of acoustic data relating to a plurality of background speakers;
a library of acoustic data relating to a plurality of reference speakers;
a database containing training sequences said training sequences relating to one or more target speakers;
an input for obtaining a speech sample from a speaker;
a memory for storing a background model and a speaker model for said one or more target speakers; and
at least one processor wherein said at least one processor is configured to:
estimate a background model based on a library of acoustic data from a plurality of background speakers;
train a set of Gaussian mixture models (GMMs) from a library of acoustic data from a plurality of reference speakers and the background model;
estimate a prior distribution of speaker model parameters using information from the trained set of GMMs and the background model, wherein correlation information is extracted from the trained set of GMMs;
estimate a speaker model for said one or more target speaker(s), using a GMM structure based on the maximum a posteriori (MAP) criterion, wherein the MAP criterion is a function of the training sequence and the estimated prior distribution;
store said background model and said speaker model in said memory
obtain a speech sample from a speaker;
evaluate a similarity measure between the speech sample and the target speaker model and between the speech sample and the background model;
verify if the speaker is a target speaker by comparing the similarity measures between the speech sample and the target speaker model and between the speech sample and the background model; and
grant access to the speaker if the speaker is verified as one of the target speakers.

4. The system of claim 3 wherein the background model directly describes elements of the prior distribution.

5. The system of claim 3 wherein the background speakers and reference speakers are representative of a particular demographic selected from a population of interest including the following: persons of selected ages, genders and cultural backgrounds.

6. The system of claim 3 wherein the library of acoustic data used to train the set of GMMs is independent of the library used to estimate the background model.

7. The system of claim 3 wherein the extracted correlation information is stored in a library.

8. The system of claim 7 wherein the library of correlation information includes estimated covariance of mixture component means extracted from the trained set of GMMs.

9. The system of claim 8 wherein a prior covariance matrix of the mixture component means is compiled based on the library of correlation information.

10. The system of claim 9 wherein the estimate of the prior covariance of the mixture component means is determined by one or more of the following estimation methods: maximum likelihood, Bayesian inference of the correlation information using the background model covariance statistics as prior information, or reducing the off-diagonal elements.

11. The system of claim 7 wherein the estimation of prior distribution of speaker model parameters is based on said library of correlation information and the background model.

12. The system of claim 3 wherein the estimation of the prior distribution further includes:
a) re-training the library of reference speaker models using the estimate of the prior distribution;
b) re-estimating the prior distribution based on the retrained library of reference speaker models; and
c) repeating steps (a) and (b) until a convergence criterion is met.

13. The system of claim 3 wherein the evaluation of the similarity measure utilises an expected frame-based log-likelihood ratio technique.

14. The system of claim 3 wherein the step of verification and identification further includes the use of post-processing techniques to mitigate speech channel effects selected from the following: feature warping, feature mean and variance normalisation, relative spectral techniques (RASTA), modulation spectrum processing and Cepstral Mean Subtraction.

15. The system of claim 3 wherein the speech sample from the speaker is provided to said input via a communications network.

16. The system of claim 3 wherein the system further utilises full target and background model coupling.

17. A method of speaker modelling, said method comprising the steps of:
estimating a background model based on a library of acoustic data from a plurality of speakers;
training a set of Gaussian mixture models (GMMs) from constraints provided by a library of acoustic data from a plurality of speakers and the background model;
estimating a prior distribution of speaker model parameters using information from the trained set of GMMs and the background model, wherein correlation information is extracted from the trained set of GMMs;
obtaining a training sequence from at least one target speaker;
estimating a speaker model for each of the target speakers using a GMM structure based on the maximum a posteriori (MAP) criterion, wherein the MAP criterion is a function of the training sequence and the estimated prior distribution.

18. A method of speaker recognition, said method comprising the steps of:
estimating a background model based on a library of acoustic data from a plurality of background speakers;
training a set of Gaussian mixture models (GMMs) from a library of acoustic data from a plurality of reference speakers and the background model;
estimating a prior distribution of speaker model parameters using information from the trained set of GMMs and the background model, wherein correlation information is extracted from the trained set of GMMs;
obtaining a training sequence from at least one target speaker;
estimating a target speaker model for each of the target speakers using a GMM structure based on the maximum a posteriori (MAP) criterion, wherein the MAP criterion is a function of the training sequence and the estimated prior distribution;
obtaining a speech sample from a speaker;
evaluating a similarity measure between the speech sample and the target speaker model and between the speech sample and the background model; and
identifying whether the speaker is one of said target speakers by comparing the similarity measures between the speech sample and said target speaker model and between the speech sample and the background model.

19. The method of claim 17 wherein the background model directly describes elements of the prior distribution.

20. The method of claim 17 wherein the speakers representative of a particular of a population of interest are selected from a particular demographic including one or more of the following: persons of selected ages, genders and/or cultural backgrounds.

21. The method of claim 17 wherein the library of acoustic data used to train the set of GMMs is independent of the acoustic data from said speakers representative of a population of interest used to estimate the background model.

22. The method of claim 17 wherein the step of extracting the correlation information includes extracting the covariance of the mixture component means from the trained set of GMMs.

23. The method of claim 22 further including the step of storing the extracted correlation information in a library.

24. The method of claim 23 further including the step of estimating a prior covariance matrix of mixture component means based on the library of correlation information.

25. The method of claim 24 further including the step of estimating the prior covariance of the mixture component means is determined by an estimation techniques chosen from: maximum likelihood, Bayesian inference of the correlation information using the background model covariance statistics as prior information, and reducing the off-diagonal elements.

26. The method of claim 23 wherein the estimation of the prior distribution of speaker model parameters is based on said library of correlation information and the background model.

27. The method of claim 17 wherein the step of estimating the prior distribution further includes the steps of:
a) re-training the library of acoustic data from a plurality of speakers using the estimate of the prior distribution;
b) re-estimating the prior distribution based on the retrained library of acoustic data from the plurality of speakers; and
c) repeating steps (a) and (b) until a convergence criterion is met.

28. The method of claim 18 wherein the evaluation of the similarity measure utilises an expected frame-based log-likelihood ratio technique.

29. The method of claim 18 wherein the step of verification and identification further includes the use of post-processing techniques to mitigate speech channel effects selected from the following: feature warping, feature mean and variance normalisation, relative spectral techniques (RASTA), modulation spectrum processing and Cepstral Mean Subtraction.

30. The method of claim 17 wherein the testing and training sequences are obtained via a communication network.

31. The method of claim 17 wherein said target model and said background model are fully coupled.
